(19) United States
(12) Patent Application Publication
(10) Pub. No.: US 2012/0173754 A1
(43) Pub. Date: Jul. 5, 2012

(54) SYSTEM AND METHOD FOR INTERFACING CONTENT PLAYBACK DEVICES WITH NETWORK SITES TO SUPPLEMENT CONTENT PLAYBACK

(76) Inventors: Michael Dalrymple, San Francisco, CA (US); Zane Vella, San Francisco, CA (US); Mark Johnson, Pasadena, CA (US)

(21) Appl. No.: 13/343,683

(22) Filed: Jan. 4, 2012

Related U.S. Application Data
(60) Provisional application No. 61/429,755, filed on Jan. 4, 2011.

(51) Int. Cl. G06F 15/16

(52) U.S. Cl. 709/231

(57) ABSTRACT

A service that enables devices to utilize various web services independent of the communication protocol and format utilized by the device, to supplement playback of content originating from a local source.

### RELATED APPLICATIONS

This application claims benefit of priority to Provisional U.S. Patent Application No. 61/429,755, filed Jan. 4, 2011, the aforementioned priority application being hereby incorporated by reference in its entirety.

### TECHNICAL FIELD

Embodiments described herein pertain generally to a web service for content playback devices, and more specifically, to a system and method for interfacing content playback devices with network sites to supplement content playback.

### BACKGROUND

Various content delivery platforms exist today, for use in enabling users to watch content in various mediums or forms, and on varying types of devices. For example, a consumer can use a set-top box, digital video recorder, smart television, tablet device, or mobile computing device to view content from many sources. The various devices, platforms and environments often implement different data standards, formats and protocols.

Additionally, technology such as provided by Blu-ray Disc include standards and data formats implemented by the Blu-ray Disc Association. Numerous documentation exists that defines the standards and requirements employed by the Blu-ray Disc Association. By way of illustration, the document entitled “Application Definition Blu-ray Disc Format,” published by the Blu-ray Disc Association in March 2005, provides descriptions of various elements in the Blu-ray format.

### BRIEF DESCRIPTION OF THE DRAWINGS

FIG. 1 illustrates a system for providing a network service to interface content playback devices with provider resources on a network, according to an embodiment.

FIG. 2 illustrates a method for implementing a service using system such as described with an embodiment of FIG. 1, according to one or more embodiments.

FIG. 3 is an illustrative data structure for use in identifying services that are to be performed in connection with requests from incoming devices or broadcast signaling to target devices, according to one or more embodiments.

FIG. 4 illustrates a computer system on which one or more embodiments described herein may be implemented.

### DETAILED DESCRIPTION

Embodiments described herein include a service that enables devices to utilize various web services independent of the communication protocol and format utilized by the device.

In particular, embodiments recognize that devices that are capable of content playback, web browsing or application presentation (web based or not) typically use communication protocols such as XML, EBIF (Enhanced TV Binary Interchange Format) or JSON (JavaScript Object Notation). For such devices, content publishers make available various forms of content, often to supplement or augment the user's playback and/or web browsing and/or interactive experience. For example, cinematic studios often publish movie previews and bonus clips on websites, which can be downloaded by or streamed to then be viewed by a device that uses an XML communication format (e.g. ANDROID device), EBIF (set-top box) or JSON. Under conventional approaches, the content publishers are required to address the various communication protocols and formats used by the various devices individually. In contrast, embodiments described herein include a service that is capable of interfacing with a device using any of multiple possible communication protocols with a web service or application server that may or may not handle the particular communication protocol.

Moreover, under embodiments described, the web service providers may update functionality and content provided without having to address various possible communication protocols that are in use in the system and/or on the device. For example, a movie production studio may offer movie trailers and products in connection with the release of a big-name movie. Rather than attempt to conform the various content and merchandise available from the site for different communication protocols, the provider web site or resource may rely on a system as described herein to interface with devices of various communication platforms. In this way, the provider may simply provide content updates for one type of communication protocol and not others. A service such as described by embodiments herein may interface with provider websites, application servers and resources in order to make their various content, products, and functionality available for content playback devices that operate under various and/or other communication platforms.

Moreover, a service such as described by various embodiments may implement provider specific configurations to enable the site to provide enhanced and controlled content experience in connection with use of specific content by a user device. Such provider specific configurations may utilize multiple sites and/or application servers, and enable performance of multiple sequenced or dependent actions to supplement use (e.g. playback) of content originating from a local source of the playback device.

While various devices and platforms are accommodated, numerous embodiments described herein include specific and enhanced functionality provided in connection with Blu-ray devices. Typically, Blu-ray devices communicate on a network using an XML communication protocol and format. Entities such as content providers of Blu-ray content may combine web content with content originating from a Blu-ray disc to supplement a playback experience of the user. With embodiments such as described, a service may interface the Blu-ray device with the content provider site and/or application servers, in order to provide in enhanced and fresh content experience to the user. The content provider site and/or application servers need not communicate using a protocol and format that accommodates the Blu-ray device in order to supplement the content and experience provided by the Blu-ray player. Rather, a service such as provided by embodiments described herein may interface the Blu-ray device to the content site and/or application servers in order to provide such enhancements and functionality. In addition, embodiments provide that devices using other communication protocols and formats may also use the same service to access the same enhancements and functionality from content providers.

Embodiments include a system and method for supplementing content playback on a content playback device. According to embodiments, playback of content that originates from a local media of a content playback device is supplemented, using content or services provided by one or more network sources that are identified on the local media.

In an embodiment, a communication is received from the content playback device. The communication specifies at least a first action that is to be performed by another network source, and can be communicated using a first communication protocol and/or format. A second communication protocol and/or format is used to communicate with the other network source. A request is generated for performance of the first action from the other network source using the second communication protocol and/or format. A response is received to the request from the other network source under the second communication protocol and/or format. A response communication is sent to the content playback device that includes the response from the other network source.

According to another embodiment, a communication is received from a content playback device. The communication is parsed or otherwise analyzed to identify a network service that is to perform each action of the communication. The network service specifies a plurality of actions that the content playback device is requesting to be performed. One or more requirements are determined for performance of the identified network service. For each service identified from the communication, a request is generated for performance of a corresponding action from the identified service. The request is generated to include the one or more requirements for that service. A response is received to the request. A response communication is sent to the content playback device that includes the response from that network service.

As used herein, BD refers to Blu-ray Disc®, and BD specification refers to the various documents that define the behavior and requirements of BD players, software and related systems, and, in particular, “System Description Blu-ray Disc Read-Only Format: Part 3. Audio Visual Basic Specifications”. The BD specification includes a section pertaining to virtual file system (“VFS”) updates.

As used herein, a “provider” refers to the entity which has control of a content that is to be played back or used. On Blu-ray Discs, the provider is, for example, the entity in charge of the content that is carried on the disc (e.g. movie studio or distributor).

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with the figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones and “tablets”) are all examples of machines and devices that utilize processors, memory, and instructions stored on computer-readable mediums. Additionally, embodiments may be implemented in the form of computer-programs, or a computer usable carrier medium capable of carrying such a program.

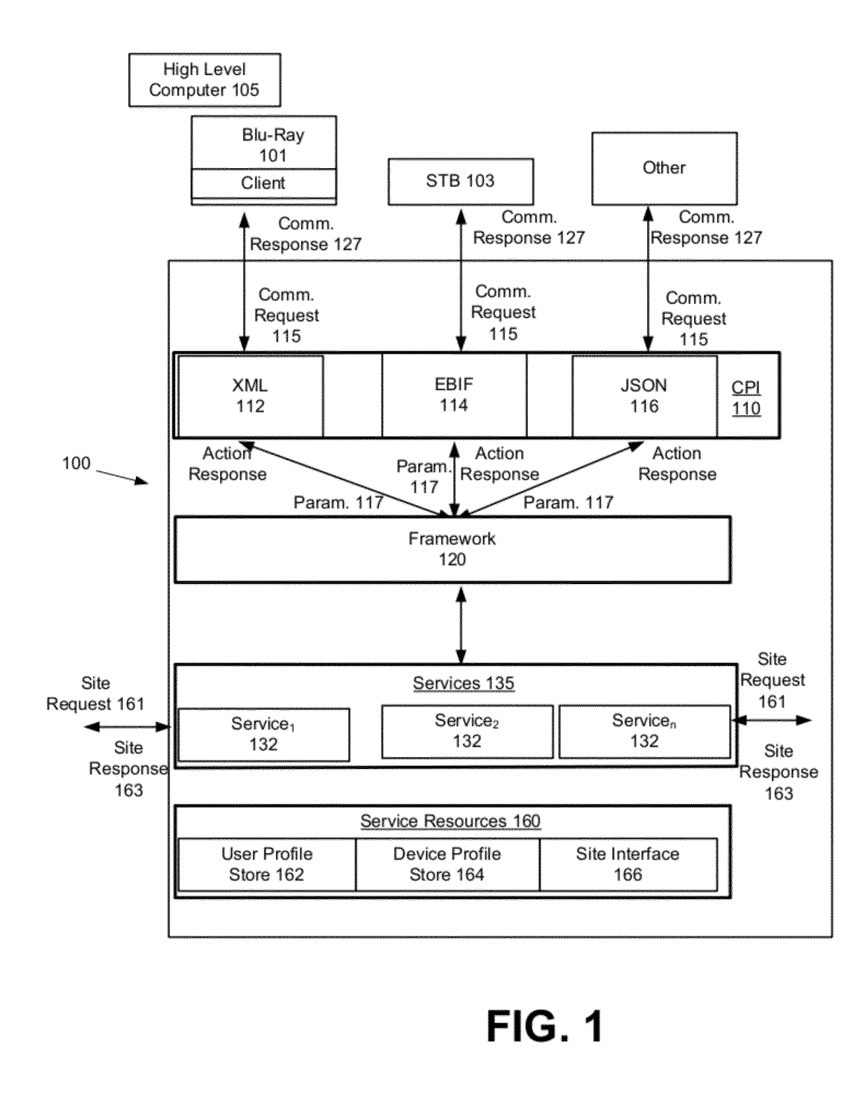

FIG. 1 illustrates a system for providing a network service to interface content playback devices with provider resources on a network, according to an embodiment. The system 100 enables content playback devices 101, 103, 105 to receive content, information and other data (e.g. programming) from provider resources over a network, regardless of the communication protocol and format used by the playback device. In some embodiments, the system 100 interfaces with devices of varying communication protocols and formats for purpose of enhancing or augmenting the playback or use of content on those devices.

According to some embodiments, the content playback devices are capable of playing content originating from a local source, such as on a Blu-ray disc, or hard drive. The provider resources may include content, information and/or functionality provided on websites of, for example, content publishers and/or distributors. The provider resources include resources provided by the provider, as well as resources provided by affiliates, partners, vendors or designated third-parties of the provider. The resources may provide content (e.g. supplemental content), functionality (e.g. interactive game), information and/or data and other features.

In FIG. 1, system 100 is implemented as a service, such as by way of one or more servers that operate to provide a website. According to some embodiments, system 100 includes a plurality of communication protocol interfaces 110 (CPI), a framework 120, and provider services 135. The system 100 also includes service resources 160, including various data profiles and site or provider interfaces. Collectively, the CPIs 110, 112, 114 and 116 provide for various communication protocols and formats to communicate with various types of devices and platforms.

The content playback devices of the user population may communicate with system 100 over the Internet under various operating conditions and environments. For at least some communications, system 100 interfaces the individual device with a provider resource, resulting in, for example, the user playback devices receiving supplemental or augmented content, information or functionality. In some embodiments, the content playback devices are configured to access system 100 automatically, and independent of playback of a particular content. In other embodiments, the content playback devices are prompted to access system 100 in response to the user interacting with functionality provided with a particular content. For example, functionality may be provided with a media file stored on a permanent memory of the user's playback device. Alternatively, the user may operate, for example, a Blu-ray environment that includes functionality for providing interaction with system 100. In some implementations, the user interaction specifically makes requests from system 100. Alternatively, the user interaction with the system 100 may be transparent, so that the user is provided supplemental content/information/functionality seamlessly from the provider resource, without the user being aware of system 100.

The manner in which the user or user device is enabled to communicate with system 100 and provider resources can also be varied. In at least some embodiments, the provider of a particular content communicates the content to the user with triggers, or input parameters that trigger the user to make requests. For example, the input parameters may enable the user to select to view movie trailers (e.g. the user elects to view a link to a movie trailer). The user playback device may convert the user's request to view trailers into a network communication to system 100 that specifies specific parameters. Depending on the implementation, the parameters may identify user's device (by class or specifically), the user (e.g. by moniker or account information), and an end result or action. According to one or more embodiments, some requests may be requested by the user. According to one or more embodiments, some requests may be generated programmatically, in response to other user input, such as to supplement the user's viewing of trailers with sponsored product information.

Alternatively, devices may be programmed or configured to automatically access system 100 over a network. For example, the Blu-ray disc may include a file that generates a user interface for enabling the viewer of the Blu-ray disc to request supplemental content (or actions for producing the supplemental content) through the input interface generated by the Blu-ray player. When the user inputs such request, the Blu-ray player automatically contacts the system and communicates the communication request 115, which includes actions or sequence of actions embedded therein. Likewise, set-top boxes may implement functionality that enables the viewer of the content to request a specific content or service (e.g. product purchase), and a set-top box may communicate the user's request to the system 100. Thus, some embodiments provide that the content provider includes functionality with the delivered content or content medium in order to automatically link the user with a system.

The triggers and/or input parameters may be provided to the playback devices using various mechanisms. In particular, the triggers and/or input parameters are embedded with the content, or media that carries the content (e.g. Blu-ray Disc). In some embodiments, the content provider specifies the triggers and/or input parameters with the content or media. As described herein, system 100 is configured to detect parameters that specify the action that is to be performed for the user and device. The actions that are to be performed for a particular request may also be specified by the provider. The actions include accessing provider resources as specified by the provider, and performing the necessary tasks to interface the user's playback device with the provider resources.

According to some embodiments, the CPIs 110 include an XML CPI 112, an EBIF CPI 114, and a JSON CPI 116. Additional interfaces for other communication protocols may also be provided for. Each CPI 110 includes functionality to handle communication requests 115 from a corresponding content playback device that utilizes the particular communication protocol and format. For example, the XML CPI 112 may communicate with Blu-ray devices 101, as well as set top box (STB) 103 that utilize operating systems such as ANDROID, iOS, FLASH or WINDOWS. The EBIF CPI 114 may handle communications from a STB 103.

System 100 may implement a particular service 132 selected from a collection of services 135, based on individual parameters and triggers included in individual requests. Individual services 132 may be specified and/or configured by content providers, who communicate and/or interact with system 100 in order to specify network resources that can be utilized by the various devices and communication protocols. Each service 132 may specify an action, or multiple actions that are to be performed for a given request (based on parameters/triggers included with the request). Additionally, each service 132 may specify data that is to be used in performing the action or actions of the service. The data may include action-specific data (e.g. URL to use to retrieve supplemental content) or service-independent data (e.g. user profile information, such as account or cookie information). In some implementations, the service is implemented as a series of instructions that execute to perform actions, including to utilizing data for performing actions.

As a more specific example, the provider may specify link to a movie preview, and enable the user to select the link. In providing such functionality, the provider does not need to accommodate the communication protocol of the content playback device. In some implementations, the content provider does not even need to specify a specific link. Rather, the content provider needs only to enable the user to access system 100 with parameters that identify the link. The system 100 associates a particular service 132 with the parameter(s) 117 identified from the request 115. The selected service 132 is executed to perform actions specified by a content provider.

In addition to services 132, the system 100 includes service resources 160 that are used in implementing the individual services 132. The service resources can include user-profile store 162, device profile store 164, and site interfaces 166. The user profile store 162 includes profile information for a plurality of users (or device operators). Depending on the implementation, the users may be identified anonymously or by account. The user profile may include, for example, information for enabling system 100 to login the operator of a device into a subscription account or e-commerce site. The device profile store may store device profiles that specify relevant characteristics of a particular device, such as its aspect ratio, firm ware version or similar information. The provider interface 166 includes instructions for generating requests for a network resource hosted at a particular website or domain or application server. Among other aspects, instructions can include the manner in which the requests are to be formatted (including the communication protocol), the data that is to be supplied along with the request (e.g. user account information), and/or the manner in which data is to be structured for completing the request. The individual interfaces to the network sites and domains may enable performance of actions that result in (i) retrieval of data (e.g. streaming media), (ii) performance of searches and identification/retrieval of results, and/or (iii) logging into user-accounts and/or identifying the user/device (anonymously or otherwise) to a network site. As a more specific example, the service 132 can include, for example, one or more of the following actions: (i) identify URLs that host one or more previews (or trailers) that are to be displayed and/or made available for display to the user; (ii) retrieve and deliver content corresponding to the identified URLs, either to display the associated previews or to enable the user to select to view the previews with some specificity; (iii) identify supplemental content associated with the particular content that is in use, such as for example, additional movie scenes or background information; and/or (iv) perform a search at an e-commerce site and display commercial products relating to the content that is in use on the user end device.

In some embodiments, the playback device has platform specific requirements that service 100 accommodates in delivering response communications. For example, in an embodiment shown, the playback device corresponds to a Blu-ray player. As such, the Blu-ray player 101 supports a virtual file system (VFS) that utilizes files located on an optical disc itself, as well as files that reside in a local storage area of the playback device itself. The Blu-ray environment generally permits updates to the environment by way of new files and content. As such, the original contents and functionality of the optical disc can be augmented through the addition of content, namely, audio and video files, or application files, such as those downloaded from a network server. Information that updates the playback environment of the Blu-ray player is received through the VFS of the playback device. The system 100 may perform functions, such as dynamically generating a manifest file for the data communicated to the player 101, as well as a digital signature that is sufficiently in compliance with Blu-ray Specifications (e.g. See System Description Blu-ray Disc Read-Only Format: Part Audio Visual Basic Specifications“). In a Blu-ray platform the manifest defines modifications that are to be made to a file system in the playback device. More specifically, the manifest file maps files located on the Blu-ray disc and in local storage to their relative positions and names in the virtual file system.

In embodiments, the CPI 110 receives the communication request 115 from a playback device that signals the request to the system 100. As described, the communication request 115 may be generated programmatically or through user input. Furthermore, the request may be made in connection with the use or playback of a specific content on a corresponding playback device. For example, the playback device may correspond to Blu-ray player 101, which is triggered by user input (e.g. user sees menu selection for ‘preview’ and clicks the menu item). The communication request 115 is processed to identify parameters/triggers 117. The framework 120 uses the parameters/triggers 117 to identify one or more services 132 for the communication request 115.

In one embodiment, the framework 120 utilizes a lookup table (see FIG. 3) or similar structure to identify the particular service (or services) associated with one or more request parameters. In turn, the service 132 identified by the request specifies one or more actions that are to be performed by the system 100 in returning a response 127 to the request. Additionally, the framework 120 identifies specific resources (from service resources 160) that are to be used in performing the action(s) specified by the service 132. For example, the actions specified by the service 132 may include accessing target data (e.g. content, information, files, code) hosted at a network location that is hosted by the content provider, or an affiliate/partner of the content provider. The resources used to perform the actions can include site-specific interfaces 166, which include programmatic instructions to the content provider (e.g. website) where the target data of the action is hosted. The framework 120 may identify and use a corresponding site interface 166 to execute instructions to implement a network connection to retrieve the target data from the location.

When the selected service 132 is executed, the service may call or otherwise utilize pertinent service resources 160 in order to perform one or more actions specified in the selected service. The actions specified in the selected service include site requests (e.g. URLs), using data and information that can be provided from the service resources 160. In one embodiment, the response 163 of the site request 161 is received and processed through the service 132 (which provides the site interface) and then communicated to the requesting playback device through the pertinent CPI 110. In one embodiment, the site interface 166 processes the data to a standard format used by system 100, and the pertinent CPI 110 converts the retrieved data into a format that is used with the communication protocol of the requesting device. To deliver content or other data to the requesting device, the framework 120 may access, for example, the pertinent device profile of the requesting device from device profile 164, as well as the user profile from the user profile store 162, in order to further configure or modify data retrieved from the provider site for use on the requesting device. In some implementations, system 100 may also establish a connection between the location of the media and the requesting device.

Among other benefits, the provider can enhance or augment the content playback experience of the user without having to accommodate the specific communication protocol, format, or characteristics of the device that is in use. Thus, the interface avoids the need for technological complexity to be hosted from the provider site, and enables a common set of actions to be available for devices that use different communication protocols (again without the need for being technologically enabled to provide for the various communication protocols and formats). Furthermore, the provider can enable multiple actions to be associated with the request, and further enable actions to be dependent on one another. In addition to avoiding the need for providing the additional level of technical functionality, the provider may correlate content, services and functionality provided at various sources (including ad domains not controlled by the provider) to provide an end user experience.

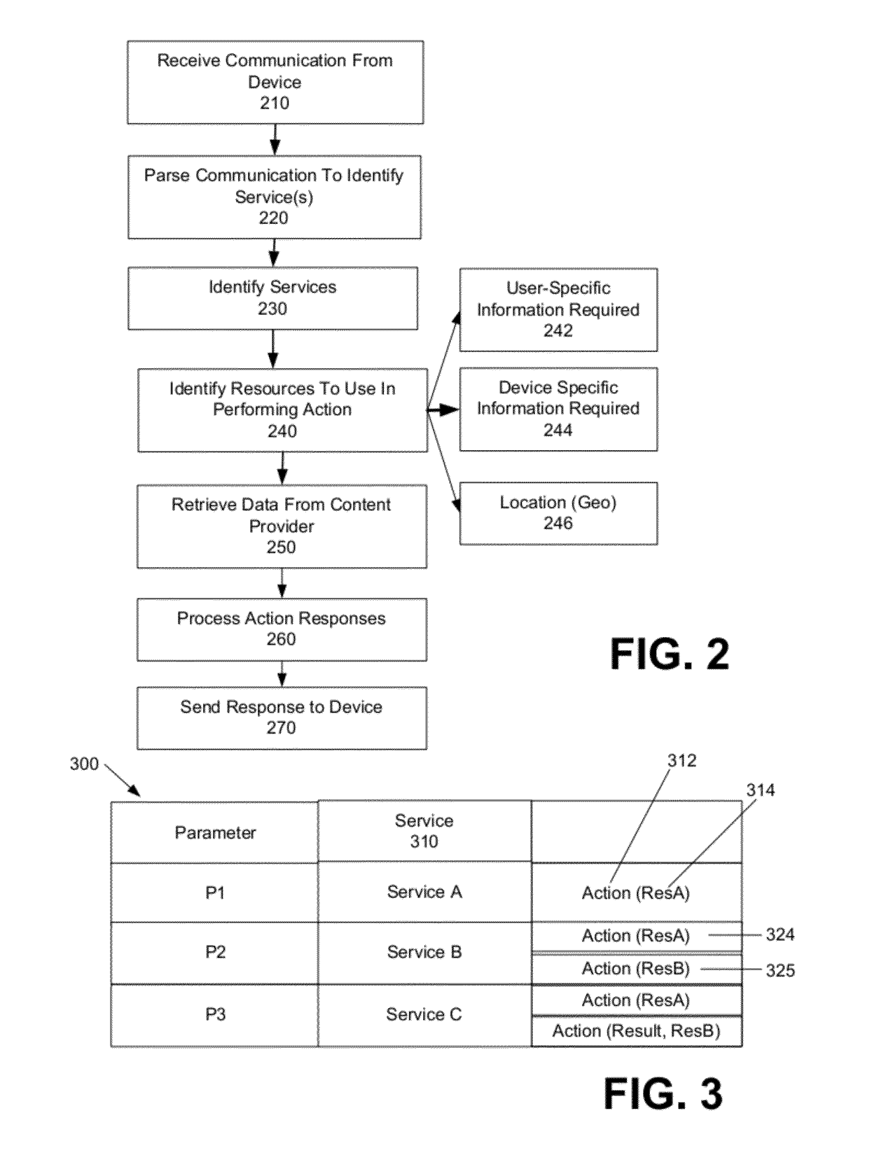

FIG. 2 illustrates a method for implementing a service using system 100, according to one or more embodiments. A method such as described by FIG. 2 may be implemented using, for example, a system such as described with an embodiment of FIG. 1. Accordingly, reference may be made to elements of FIG. 1 for purpose of illustrating suitable components for performing a step or sub step being described.

According to an embodiment, system 100 receives a communication request from a given playback device (210). The playback device may communicate with system 100 through various possible communication protocols. System 100 may include CPI 110 for specific communication protocol formats. Among other benefits, similar enhancements and/or augmentations can be provided for content playback that is rendered on different types of devices and platforms. For example, a content segment (e.g. movie title) may be associated with multiple movie trailers, and playback of that movie may result in the same set of movie trailers being provided to the user playback device is a Blu-ray player or set-top box. Moreover, the content provider may update the movie trailers that are available to the playback device without regard to the device or communication format in use (e.g. Blu-ray player versus set-top box).

The framework 120 of system 100 parses the communication request for parameters and/or triggers that identify actions that are to be performed with the communication request (220). In embodiments, the actions include accessing network locations or sites hosted by content providers in order to retrieve data such as content or programming. As part of identifying the actions, the framework 120 identifies interfaces for connecting and retrieving data from the identified network locations (230). The interfaces may specify requirements in the form of (i) protocol/format requirements, (ii) request structuring and (iii) data required (e.g. user account information) in making the connection to the identified network locations.

Additionally, the performance of actions may require use of data maintained by system 100 (240). The examples of such data include device profile (e.g. device type, hardware characteristics) (244), the user profile (e.g. account information) (242), and the geographic location of the user (246), obtained from a Geolocation detection application server or website service. As mentioned with an embodiment of FIG. 1, the performance of the actions may be formatted as services, which specify the action(s) and data that are to be performed in order to fulfill a request.

The framework 120 may perform one or more actions specified in the user's request using appropriate resources (e.g. site interface, user data). According to some embodiments, the actions may include retrieving data from a network location specified by the content provider (250). In some embodiments, multiple such actions may be performed. Furthermore, some actions can be implemented in sequence, using data resulting from a prior action. For example, in some embodiments, a user's geographic location may be retrieved from a first site (e.g. geo-locations service), then supplied to a second site to generate geographic pertinent content or data. Accordingly, one or more services 132, identified for individual requests, may be generated using data specified in the request, in resources of system 100 (e.g. user profile), and/or from data resulting in prior requests.

The action or service responses may be processed through system 100. In one embodiment, the site-specific interfaces implement communication protocols to receive and process the responses from the sites where data is requested (260). The data generated from the responses may be communicated to the requesting devices using the communication protocol and format of the requesting device (270). As described with an embodiment of FIG. 1, the pertinent CPI 110 may communicate the action response 127 to the requesting device.

FIG. 3 is an illustrative data structure for use in identifying services that are to be performed in connection with requests from incoming devices, according to one or more embodiments. With reference to FIG. 1, framework 120 of system 100 may utilize a lookup table 300 to identify the actions and resources needed to complete a user request. In one embodiment, the framework 120 utilizes the lookup table 300 associate a service 310 with a particular request parameter. Each service 310 may specify an action 312 and one or more sets of resources 314 that are needed to perform the action. The action 312 of the service may correspond to retrieval of data (e.g. content or programming). The resources 314 include instructions for implementing an interface or connection to the location of the data that is to be retrieved. Additionally, the resources 314 may include user profile data, device profile data, and/or site-specific instructions for structuring data and or accessing data from the particular location or domain.

A request parameter may also correlate to a service that requires the performance of multiple actions. As shown by Service B, concurrent actions 324, 325 may be performed in response to a single request (e.g. retrieval of data/content from multiple sites). Each of the concurrent actions 324, 325 may require resources (e.g. communication protocol conversion, system resources such as user profile), resulting in separate retrievals and further conversion for communication back to the requesting device. Service C further illustrates that actions may be performed in sequence and be dependent on one another. For example, a second action may require use of resources and a result from performance of a prior action. The result returned to the requesting device may incorporate data generated from the second action (e.g. second network retrieval) using results generated from a first action (e.g. geo-location lookup).

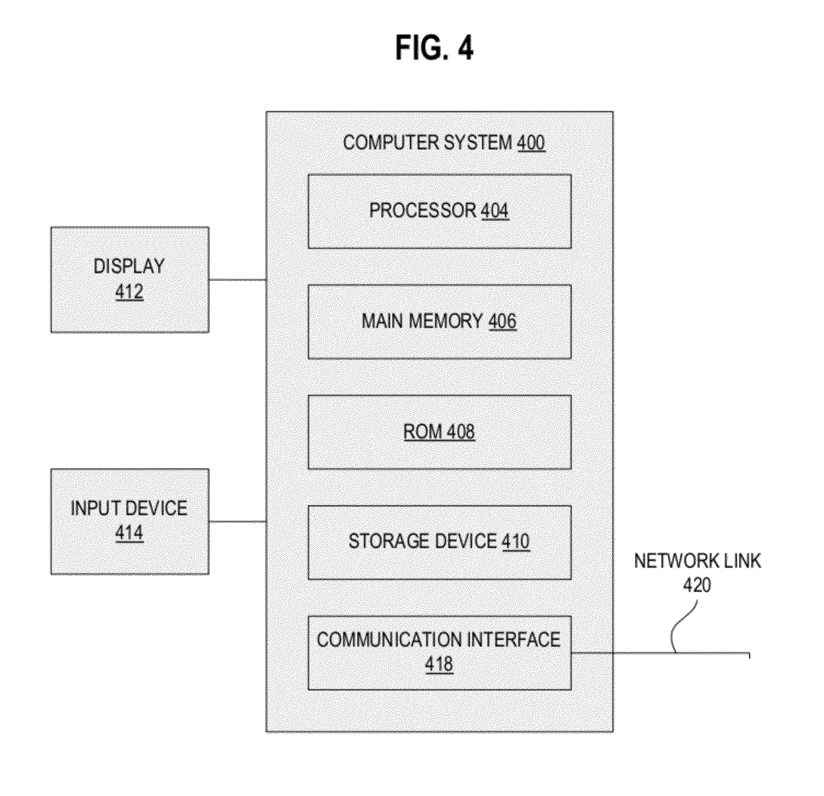

FIG. 4 illustrates a computer system on which one or more embodiments described herein may be implemented. For example, with regard to FIG. 1, a server, or combination of servers can be used to implement system 100 as, for example, a network service. Similarly, a computing system of FIG. 4 may be used to implement a method such as described with an embodiment of FIG. 2.

Computer system 400 includes at least one processor 404 for processing information. Computer system 400 also includes a main memory 406, such as a random access memory (RAM) or other dynamic storage device, for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device for storing static information and instructions for processor 404. A storage device 410, such as a magnetic disk or optical disk, is provided for storing information and instructions.

Computer system 400 may be coupled to a display 412, such as a cathode ray tube (CRT), a LCD monitor, and a television set, for displaying information to a user. An input device 414, including alphanumeric and other keys, is coupled to computer system 400 for communicating information and command selections to processor 404. Other non-limiting, illustrative examples of input device 414 include a mouse, a trackball, or cursor direction keys for communicating direction information and command selections to processor 404 and for controlling cursor movement on display 412. While only one input device 414 is depicted in FIG. 4, embodiments of the invention may include any number of input devices 414 coupled to computer system 400.

Embodiments of the invention are related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement embodiments of the invention. Thus, embodiments of the invention are not limited to any specific combination of hardware circuitry and software.

The term “machine-readable storage medium” as used herein refers to any medium that participates in storing instructions which may be provided to processor 404 for execution. Such a medium may take many forms, including but not limited to, non-volatile media and volatile media. Non-volatile media includes, for example, optical or magnetic disks, such as storage device 410. Volatile media includes dynamic memory, such as main memory 406.

Examples of machine-readable media include, for example, a floppy disk, a flexible disk, hard disk, magnetic tape, or any other magnetic medium, a CD-ROM, any other optical medium (e.g., Blu-ray Disc), a RAM, a PROM, and EPROM, a FLASH-EPROM, any other memory chip or cartridge, or any other medium from which a computer can read.

Various forms of machine readable media may be involved in carrying one or more sequences of one or more instructions to processor 404 for execution. For example, the instructions may initially be carried on a magnetic disk of a remote computer. The remote computer can load the instructions into its dynamic memory and send the instructions over a network link 420 to computer system 400.

Communication interface 418 provides a two-way data communication coupling to a network link 420 that is connected to a local network. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through a local network to a host computer or to data equipment operated by an Internet Service Provider (ISP).

Computer system 400 can send messages and receive data, including program code, through the network(s), network link 420 and communication interface 418. For example, a server might transmit a requested code for an application program through the Internet, a local ISP, a local network, subsequently to communication interface 418. The received code may be executed by processor 404 as it is received, and/or stored in storage device 410, or other non-volatile storage for later execution.

Although illustrative embodiments have been described in detail herein with reference to the accompanying drawings, variations to specific embodiments and details are encompassed by this disclosure. It is intended that the scope of the invention is defined by the following claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computer implemented method for supplementing content playback on a content playback device, the method comprising:
supplementing playback of content that originates from a local media of a content playback device, using content or services provided by one or more network sources that are identified on the local media, wherein supplementing playback of content from the local media includes using one or more processors to execute steps at a network site that include:
receiving a communication from the content playback device, the communication specifying at least a first action that is to be performed by another network source, the communication being communicated using a first communication protocol and/or format;
identifying a second communication protocol and/or format that is used to communicate with the other network source;
generating a request for performance of the first action from the other network source using the second communication protocol and/or format;
receiving a response to the request from the other network source under the second communication protocol and/or format; and
sending a response communication to the content playback device that includes the response from the other network source.

2. The method of claim 1, wherein the local media corresponds to a removable media that is dedicated for playback of a particular content.

3. The method of claim 2, wherein the local media corresponds to a disk or mass storage device.

4. The method of claim 2, wherein the local media is standardized and published by an authorized publisher.

5. The method of claim 1, wherein the local media corresponds to a Blu-ray disc.

6. A computer implemented method for supplementing content playback on a content playback device, the method being implemented by one or more processors that execute at a network site, the method comprising:
receiving a communication from a content playback device;
parsing the communication to identify a network service that is to perform each action of the communication, the network service specifying a plurality of actions that the content playback device is requesting to be performed;
determining one or more requirements for performance of the identified network service, the one or more requirements including a communication protocol and/or format required from each network service; and
for each service identified from the communication:
generating a request for performance of a corresponding action from the identified service, the request being generated to include the one or more requirements for that service;
receiving a response to the request; and
sending a response communication to the content playback device that includes the response from that network service.

7. The method of claim 6, wherein the one or more requirements of the network service include user-specific data that is stored at the network site.

8. The method of claim 7, wherein the user-specific data includes information for accessing a user account associated with the content playback device.

9. The method of claim 6, wherein sending the response communication includes identifying device-specific data of the content playback device.

10. The method of claim 6, wherein determining one or more requirements of each identified network service includes identifying a communication protocol required from each network service.

11. The method of claim 6, further comprising generating the communication from the content playback device in response to the content playback device being instructed to playback media content.

12. The method of claim 6, further comprising identifying a type and of the content playback device, and sending the response to the content playback device in a manner that accommodates one or more requirements of the media player.

13. A computer-readable medium that stores instructions for supplementing content playback on a content playback device, the instructions being executable by one or more processors to perform operations comprising:
supplementing playback of content that originates from a local media of a content playback device, using content or services provided by one or more network sources that are identified on the local media, including:
receiving a communication from the content playback device, the communication specifying at least a first action that is to be performed by another network source, the communication being communicated using a first communication protocol and/or format;
identifying a second communication protocol and/or format that is used to communicate with the other network source;
generating a request for performance of the first action from the other network source using the second communication protocol and/or format;
receiving a response to the request from the other network source under the second communication protocol and/or format; and
sending a response communication to the content playback device that includes the response from the other network source.

14. The computer-readable medium of claim 13, wherein the local media corresponds to a removable media that is dedicated for playback of a particular content.

15. The computer-readable medium of claim 14, wherein the local media corresponds to a disk or mass storage device.

16. The computer-readable medium of claim 14, wherein the local media is standardized and published by an authorized publisher.

17. The computer-readable medium of claim 14, wherein the local media corresponds to a Blu-ray disc.

18. A computer-readable medium that stores instructions for supplementing content playback on a content playback device, the instructions being executable by one or more processors to perform operations comprising:
receiving a communication from a content playback device;
parsing the communication to identify a network service that is to perform each action of the communication, the network service specifying a plurality of actions that the content playback device is requesting to be performed;
determining one or more requirements for performance of the identified network service, the one or more requirements including a communication protocol and/or format required from each network service;
for each service identified from the communication:
generating a request for performance of a corresponding action from the identified service, the request being generated to include the one or more requirements for that service;
receiving a response to the request; and
sending a response communication to the content playback device that includes the response from that network service.

19. The computer-readable medium of claim 18, wherein the one or more requirements of the network service include user-specific data that is stored at the network site.

20. The computer-readable medium of claim 19, wherein the user-specific data includes information for accessing a user account associated with the content.

21. The computer-readable medium of claim 18, wherein the operation of sending the response communication includes identifying device-specific data of the content playback device.

22. The computer-readable medium of claim 18, wherein the operation of determining one or more requirements of each identified network service includes identifying a communication protocol required from each network service.

23. The computer-readable medium of claim 18, further comprising instructions for performing the operation comprising generating the communication from the content playback device in response to the content playback device being instructed to playback media content.

24. The computer-readable medium of claim 18, further comprising instructions for performing the operations comprising (i) identifying a type and of the content playback device, and (ii) sending the response to the content playback device in a manner that accommodates one or more requirements of the media player.
